(19) United States
(12) Patent Application Publication
(10) Pub. No.: US 2026/0066184 A1
(43) Pub. Date: Mar. 5, 2026

(54) SYSTEMS AND METHODS FOR A ROTATING TRANSFORMER

(71) Applicant: DANA TM4 INC., Boucherville (CA)

(72) Inventors: Jordi VAN DAMME, Eke (BE); Rafaël BÉDARD, Otterburn Park (CA)

(21) Appl. No.: 18/825,391

(22) Filed: Sep. 5, 2024

(51) Int. Cl. H01F 27/30; H01F 38/18

(52) U.S. Cl. CPC H01F 27/306; H01F 38/18; H01F 41/04

(57) ABSTRACT

Systems and methods of manufacture for a rotating transformer are herein provided. In one example, a rotating transformer comprises a rotating part and a static part, wherein the rotating part comprises a rotor core coupled to a first winding via a first spring retainer and the static part comprises a stator core coupled to a second winding via a second spring retainer.

### TECHNICAL FIELD

Embodiments of the subject matter disclosed herein relate electric machines, and more particularly to a rotating transformer of an electric machine that includes a spring retainer.

### BACKGROUND AND SUMMARY

Electric vehicles and partially electric vehicles utilize electric machines to power drivetrains of the vehicle. Common types of electric machine are permanent magnet PM synchronous machines (PMSMs) and asynchronous machines (ASMs), however ASMs have low efficiency compared to PMSMs. While PMSMs are more efficient than ASMs, manufacture of PMSMs include mining rare-earth minerals for the permanent magnets, which is not sustainable due to environmental and geopolitical challenges. Thus, for ecological and economical reasons, electric machines without rare-earth magnets are increasingly desirable.

An alternative solution to PMSMs that does not require mining of rare-earth materials for magnets is the externally excited synchronous machine (EESM). Instead of rare-earth permanent magnets providing the magnetic field in the rotor, an electromagnet is used. EESMs require power transfer to the rotor which can be accomplished through various means such as carbon brushes or a rotating transformer. Rotating transformers have the advantage of being maintenance free and eliminate friction losses. For example, the rotating transformer often uses a foil (e.g., copper or aluminum) winding to limit alternating current (AC) losses. The coil may be affixed to a ferrite core of the rotating transformer using organic adhesives or other types of adhesives, such as Kapton tape, an epoxy resin, or the like.

However, such adhesives may include a wet manufacturing process which increases complexity and manufacturing expenditure. Further, use of such adhesives reduces the ability to recycle the components of the rotating transformer at end-of-life. Further still, the maximum allowable temperature of the adhesive materials (e.g., 252° C.) may be lower than the ceramic winding insulation materials of the foil winding of the rotating transformer, thereby not allowing for full exploitation of the temperature capabilities of the transformer.

The inventors herein have recognized the aforementioned issues and developed a rotating transformer with a spring retainer that at least partially addresses these issues. The rotating transformer as herein disclosed utilizes the spring retainer to replace the bonding of the coil with adhesive. The spring retainer may thus couple the copper coil windings to the ferrite core. In particular, the rotating transformer includes a static part and a rotating (e.g., rotor) part. During manufacture, for the static part, by compressing the spring, the radius of the spring may increase and the spring may be shifted over the foil winding. When the pressure is released, the spring may exert a force on the winding, thereby maintaining the position of the winding within the stator. Further, for the rotating part, by elongating the spring, the radius of the spring will decrease. When the radius is decreased, the foil coil winding of the rotating part can be wrapped around the spring. When the winding is wrapped around the spring, the assembly is assembled with the rotor core and then when the elongation pressure is released, the winding may be fixed inside the rotor core.

In this way, the rotor core and the foil winding may be fixed together without the use of adhesives. Without adhesives, the temperature capabilities of the rotating transformers may be fully exploited during use. Further, without the adhesives, the manufacturing process may be more efficient and require less expenditure. Additionally, without adhesives, the components of the rotating transformer may be recycled at end-of-life, thereby increasing overall sustainability.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an exemplary vehicle.

FIG. 2A shows a rotor portion of a disassembled rotating transformer.

FIG. 2B shows a stator portion of the disassembled rotating transformer.

FIG. 3 shows a cross-section of an assembled rotating transformer.

FIG. 4A shows a schematic cross-section of an assembled rotating transformer according to a first embodiment.

FIG. 4B shows a schematic cross-section of the assembled rotating transformer according to a second embodiment.

FIG. 5 shows a method of manufacture of a static part of a rotating transformer.

FIG. 6 shows a method of manufacture of a rotating part of a rotating transformer.

### DETAILED DESCRIPTION

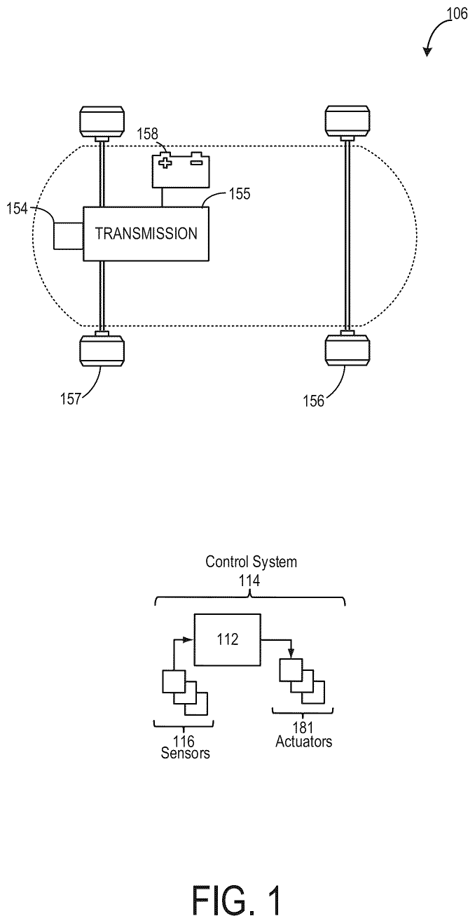

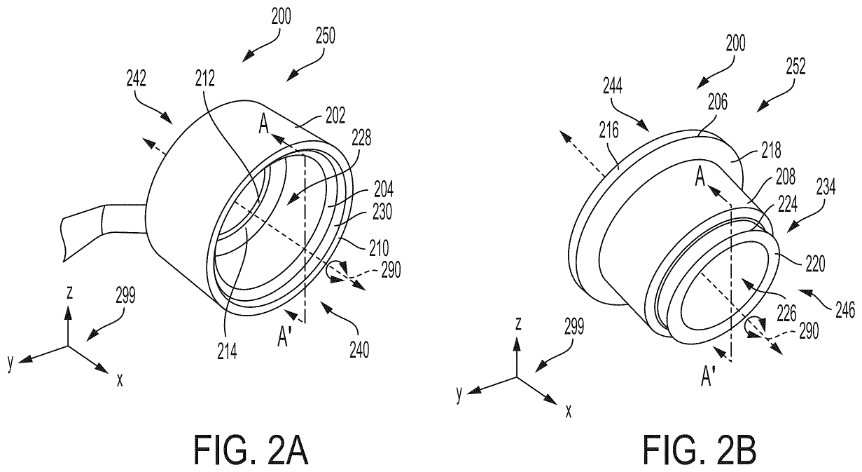

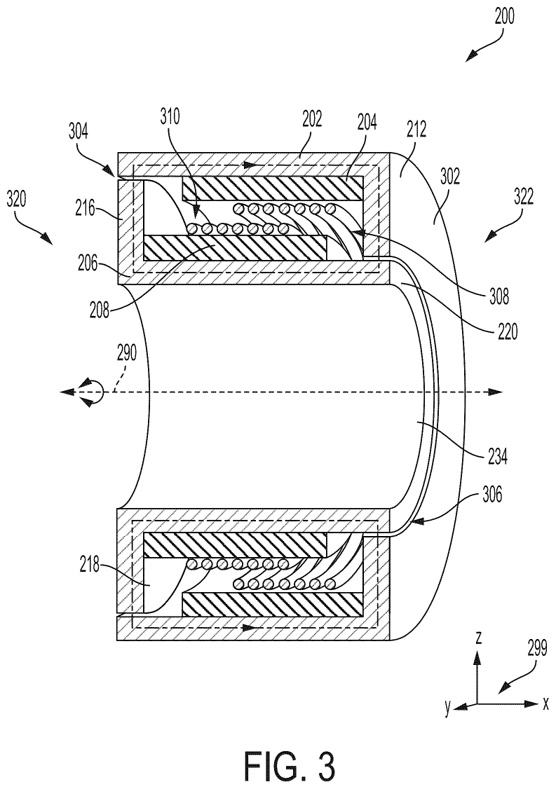

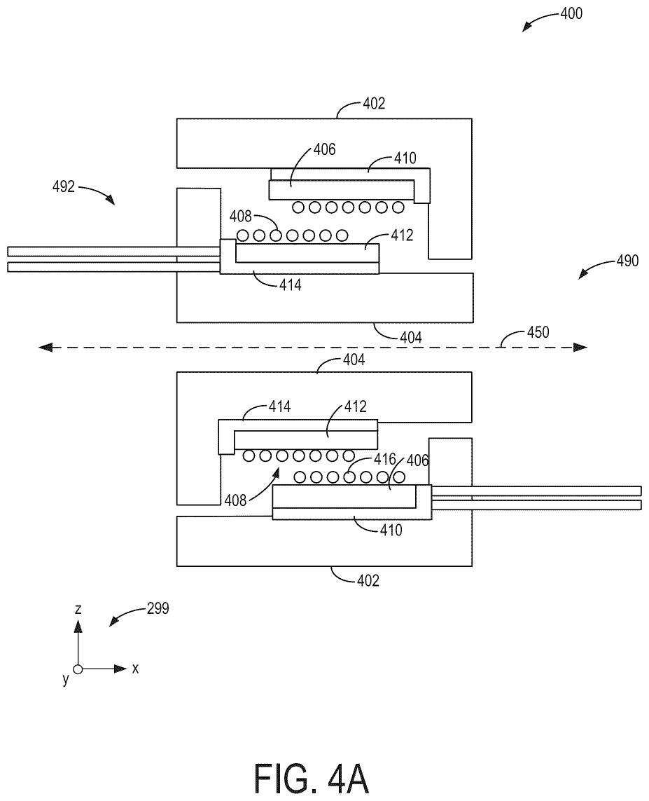

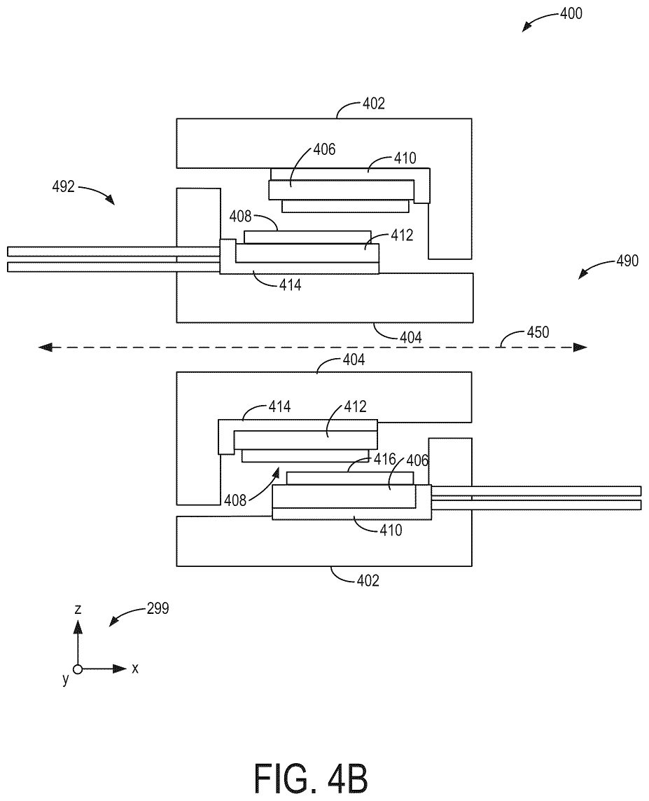

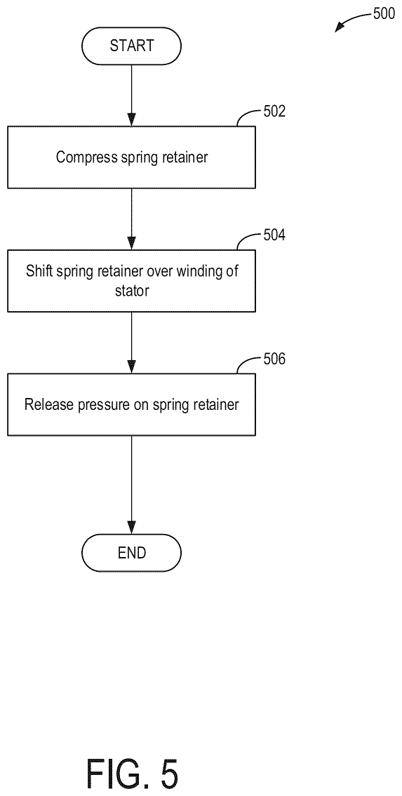

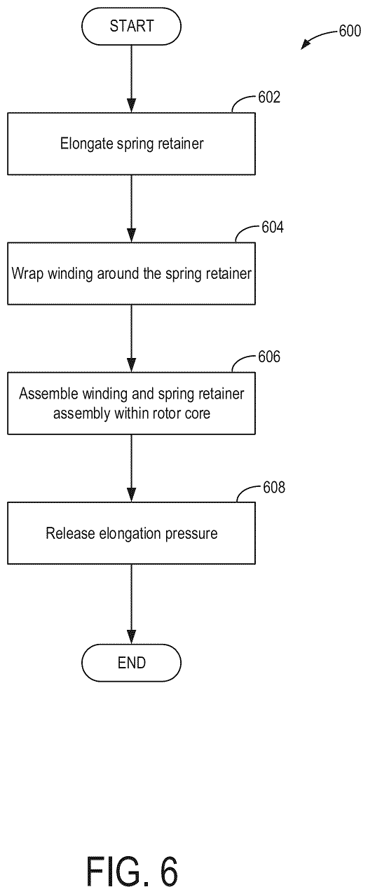

The following description relates to systems and methods for a rotating transformer that includes a spring retainer configured to affix coil windings of the rotating transformer to a ferrite core. FIG. 1 shows an exemplary vehicle system in which a rotating transformer according to the present disclosure may be incorporated. FIGS. 2A and 2B show disassembled stator and rotor parts of an exemplary rotating transformer. FIG. 3 shows a cross-section of the exemplary rotating transformer. FIGS. 4A and 4B show a cross-sectional schematic views of a rotating transformer according to a first and second embodiment. FIGS. 5 and 6 show flowcharts illustrating methods for manufacturing the stator and rotor parts of a rotating transformer with a spring retainer.

FIGS. 1-4B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to the figures, FIG. 1 shows a schematic depiction of a vehicle system 106 that can derive propulsion power from one or more electric machines 154 (e.g., a drive motor). The one or more electric machines 154 as herein described may be externally excited synchronous machines (EESMs) that use an electromagnet to provide a magnetic field. To transfer power to a rotor of the electric machine, the electric machines 154 may comprise a rotating transformer, as will be herein described. In some examples, the vehicle system 106 may be an on-road vehicle, such as a car or truck, an off-road vehicle, or any other type of vehicle that utilizes an electric machine. Further, the vehicle system 106 may be a battery electric vehicle (BEV), a hybrid electric vehicle (HEV), or a plug-in hybrid electric vehicle (PHEV). In one embodiment, the electric machines 154 may be traction motors or another type of electric motor. Electric machines 154 may receive electrical power from a traction battery 158 to provide torque to rear vehicle wheels 157 via transmission 155. Electric machines 154 may also be operated as a generator to provide electrical power to charge traction battery 158, for example during a braking operation. It should be appreciated that while FIG. 1 depicts electric machines 154 and transmission system 155 mounted in a rear wheel drive configuration, other configurations are possible, such as employing the electric machine 154 in a front wheel configuration, or in a configuration in which a first output yoke or other interface drives the rear wheels 157 and a second output yoke or other interface drives front vehicle wheels 156.

Electric machines 154 and transmission 155 may be included as part of an electric drive unit. In some examples, the electric machines 154 may be integrated with a gearbox of the transmission system 155. Additionally or alternatively, the electric machines 154 may be coupled to an outside of a transmission/gearbox housing. The transmission/gearbox may include at least one clutch and one or more shafts, as will be described below. Controller 112 may send a signal to an actuator of the clutch(es) of the transmission system 155 to engage or disengage the clutch(es), so as to couple or decouple power transmission from the electric machines 154 to various shafts and gears therein, thereby changing gear ratios of the transmission system 155.

Controller 112 may form a portion of a control system 114. Control system 114 is shown receiving information from a plurality of sensors 116 and sending control signals to a plurality of actuators 181. As one examples, sensors 116 may include sensors such as battery state of charge sensors, clutch pressure sensors, speed sensors, pedal actuation sensors, etc. As another examples, the actuators may include the clutch(es), etc. The controller 112 may receive input data from the various sensors, processing the input data, and trigger the actuators in response to the processed input data based on instruction or code programmed therein corresponding to one or more routines.

Turning now to FIGS. 2A and 2B, an exemplary rotating transformer 200 is shown. The rotating transformer as shown in FIGS. 2A and 2B as disassembled, wherein FIG. 2A specifically shows a rotating part 250 of the rotating transformer 200 and FIG. 2B specifically shows a static part 252 of the rotating transformer 200. The rotating transformer 200 may be configured to cooperate with a rotor shaft of an electric machine, such as one or more of the electric machines 154 of FIG. 1. An axis system 299 is provided in FIG. 2A as well as FIGS. 2B-4B. An x-axis may be a lateral axis, a y-axis may be a longitudinal axis, and a z-axis may be a vertical axis (e.g., parallel with a gravitational axis), in some examples, however other axes may be possible.

The rotating transformer 200 may comprise a ferromagnetic core, conductive windings, such as copper or aluminum windings, and one or more springs (e.g., spring retainers such as coil springs, sheet/foil springs, or strip springs), as herein disclosed. In the disassembled state, as shown in FIGS. 2A-2B, the spring retains may not be present. As will be described with respect to FIGS. 5 and 6, during manufacture and assembly, the spring retainers may be positioned within and around the rotating part 250 and the static part 252, respectively. The rotating part 250 and the static part 252 may be configured to be assembled together, as shown in FIGS. 3-4B. The rotating transformer 200 may rotate about an axis of rotation 290. The rotating transformer 200 may be concentrically and coaxially mounted on the rotor shaft during assembly with the electric machine such that the axis of rotation 290 of the rotating machine is also the axis of rotation of the rotor shaft.

The rotating part 250 may comprise a rotor core 202 made of ferromagnetic material (e.g., ferrite core) and the static part 252 may comprise a stator core 206 made of ferromagnetic material. The rotor core 202 may be coupled to a first winding 204. Similarly, the stator core 206 may be coupled to a second winding 208. The first and second windings 204, 408, and other windings herein disclosed, may be copper windings, aluminum windings, or other types of windings. As will be further described with respect to FIGS. 4A-6, the first and second windings 204, 208 may be coupled to the ferromagnetic core via respective spring retainers.

The rotor core 202 may be configured as a cylinder shaped tube or a segmented cylinder shaped tube. The first winding 204 of the rotating part 250 may be positioned within an inside 228 of the rotor core 202. For example, the rotor core 202 may include an inner cylindrical face 230. An outer surface of the first winding 204 may interface with the inner cylindrical face 230 of the rotor core 202 such that the first winding 204 is positioned within an interior of the rotor core 202. The rotor core 202 may comprise a first outer face 210 at a first side 240. At a second side 242 of the rotor core 202, a lip 212 may comprise a first inner face 214 positioned towards the inside 228 and a second outer face (not shown). The second outer face may face in an opposite direction from the first outer face 210.

The static part 252 may also be configured as a cylinder shaped tube 234 with a lip 216. The second winding 208 may be positioned around an exterior of the cylinder shaped tube 234 of the stator core 206. For example, an outer cylindrical surface 224 may interface with the second winding 208. An inside space 226 of the stator core 206 may be configured for a rotor shaft to be positioned within. The stator core 206 may comprise the lip 216 at a first side 244 and a first outer face 220 at a second side 246. The lip 216 may comprise a first inner face 218 and a second outer face (not shown).

During assembly of the rotating transformer 200, the tube 234 of the static part 252 may be inserted into the inside 228 of the rotating part 250. For example, the first outer face 220 may be positioned near the first inner face 214 of the lip 212 of the rotor core 202 and the first inner face 218 of the lip 216 of the stator core 206 may be positioned near the first outer face 210 of the rotor core 202. In this way, the first and second windings 204, 206 may face each other within the assembled rotating transformer. When assembled, the rotating part 250 of the rotating assembly may rotate about the static part 252, for example about the axis of rotation 290, which the static part 252 remains stationary.

A cutting plane A-A′ is depicted through both the rotating part 250 and the static part 252 in FIGS. 2A and 2B. FIG. 3 depicts the rotating transformer 200 in a cross-sectional view through the cutting plane A-A′. As described above, when assembled, as shown in FIG. 3, the lip 216 of the static part 252 and the first outer face 210 of the rotating portion 250 may be positioned at a first side 320 while the first outer face 220 of the static part 252 and the lip 212, specifically an outer face 302 of the lip, may be positioned at a second side 322.

In some examples, a first air gap 304 may exist between the lip 216 of the stator core 206 and the rotor core 202. Similarly, a second air gap 306 may exist between the tube 234 of the stator core 206 and the lip 212 of the rotor core 202. The first and second air gaps 304 and 306 may be where the main magnetic flux goes from rotor to stator, thus linking the rotor and stator magnetically. The first and second air gaps 304 and 306 are thus configured to establish the function of the transformer. For example, the second air gap 306 may create a clearance between the spring retainer and the windings of the static and rotating parts to accommodate for potential geometrical tolerances of the windings and spring retains. Further the first and second air gaps 304, 306 may reduce contact between the static and rotating parts during rotation of the rotating transformer, thereby reduction potential degradation to the system.

When assembled, the rotating transformer 200 may comprise a first spring 310 and a second spring 308. As will be further described with respect to FIGS. 4A-6, the first spring 310 may be positioned around the static part 252 and the second spring 308 may be positioned within the rotating part 250. The first spring 310 may maintain a position of the second winding 208 against the stator core 206 and the second spring 308 may maintain a position of the first winding 204 against the rotor core 202.

In some examples, the second winding 208 of the static part 252 may be coupled to an external alternating current (AC) power source. The first winding 204 of the rotating portion 250 may be electrically connected to rotor field windings (not shown) of the EESM. The second winding 208 may be configured to be energized by the external AC power source to create a time-varying magnetic field. This magnetic field may induce an alternating magnetic flux in the ferrite core, which comprises the rotor core 202 and the stator core 206.

The alternating magnetic flux produced by the second winding 208 may link with the first winding 204. As shown in FIG. 3, the first and second windings 204, 208 may be positioned within the ferrite core facing each other. The alternating magnetic flux linked with the first winding 204 may induce an alternating voltage in the first winding 204, even when the rotating part is stationary. This induced alternating voltage results in an alternating current which may consequently be rectified by a rectifier attached to the rotating side of the transformer to produce a direct current (DC) for the rotor field windings. This DC output to the rotor field windings may thus generate the rotor's magnetic field for synchronous operation of the EESM. The rotor and stator circuits, as herein described, may be isolated from each other, reducing potential electrical faults As will be described below, the conductive windings may be coupled to the ferromagnetic core via elongation and compression of the spring retainer. Further, as will be described below, while the first and second spring retainers 310, 308 of FIG. 3 are depicted as wire springs, other embodiments are possible. For example, the spring retainers may be configured as foil springs.

Turning now to FIGS. 4A and 4B, a schematic cross-sectional depiction of a rotating transformer 400 is shown. The rotating transformer 400 may be similar to the rotating transformer 200 described with respect to FIGS. 2A-3, in some examples. The rotating transformer may be included in an electric machine, such as an EESM (e.g., electric machine 154 of FIG. 1). In a first embodiment, as shown in FIG. 4A, spring retainers included in the rotating transformer are wire springs. In a second embodiment, as shown in FIG. 4B, the spring retainers are foil springs. FIGS. 4A and 4B have the at least some of the same components and thus such components will not be reintroduced, for brevity.

In both the first and second embodiments herein described, the rotating transformer 400 may comprise a rotor core 402 and a stator core 404. The rotor core 402 and the stator core 404 may together form the core, for example a ferrite or ferromagnetic core, of the rotating transformer 400. As described with respect to FIGS. 2A-3, the rotor core 402 and the stator core 404 may be separate pieces that are assembled together, as shown in FIGS. 4A and 4B. A first winding 406 may be coupled to the rotor core 402. The first winding 406 may be a copper or aluminum winding or other type of foil or coil winding made of conductive material. The first winding 406 may be positioned within an interior of the rotor core 402. A first slot liner 410 may be positioned between the first winding 406 and the rotor core 402, in some examples. A second winding 412 may be coupled to the stator core 404. The second winding 412, similar to the first winding 406, may be a copper or aluminum winding or other type of foil or coil winding made of conductive material. The second winding 412 may be positioned around an exterior of the stator core 404, in some examples. A second slot liner 414 may be positioned between the second winding 412 and the stator core 404, in some examples. The first and second slot liners 410, 414 may be configured to provide an insulation barrier between the windings and the rotor core 402 and stator core 404, respectively, in some examples.

The first and second windings 406, 412 may extend laterally out from the core, for example the first winding 406 may extend laterally out to a first side 490 and the second winding 412 may extend laterally out to a second side 492. The lateral extensions of the windings may allow for generation of a magnetic field and thus production of DC. For example, the lateral extensions may be used to connect the static winding to the alternating current source and the rotating winding to the rectifier.

The rotating transformer 400 may rotate about an axis of rotation 450. In some examples, when assembled, the rotor core 402 may be a rotational component that rotates about the stator core 404, as described above.

The rotating transformer 400 may additionally comprise a first spring retainer 408 and a second spring retainer 416. The first and second spring retainers 408 and 416 may be positioned between the first winding 406 and the second winding 412 when the rotating transformer is assembled. The first spring retainer 408 may be a stator spring retainer configured to couple the second winding 412 to the stator core 404. The second spring retainer 416 may be a rotor spring retainer configured to couple the first winding 406 to the rotor core 402. The first spring retainer 408 may be positioned about the stator part of the rotating transformer 400 (e.g., the second winding 412 and the stator core 404 assembly), wherein being positioned about the stator part, in this instance, includes being positioned about an exterior of the stator part. The second spring retainer 416 may be positioned within the rotor part of the rotating transformer 400, for example within an interior of the first winding 406 and rotor core 402.

The spring retainers may be configured with a shape that optimizes losses and mechanical aspects for the rotating transformer 400. For example, the spring may comprise foil springs or wire springs. As an example, the springs may be shaped and sized such that they do not contact each other when the stator core and rotor core are assembled together. In the first embodiment shown in FIG. 4A, when the springs are wire springs, the wire diameter, material, and number of turns may be optimized to balance mechanical force exerted by the spring on the windings and additional losses induced in the spring. Similarly, in the second embodiment shown in FIG. 4B, when the springs are foil springs, the foil spring thickness and material may be optimize to balance the same aspects.

As will be described with respect to FIGS. 5 and 6, the spring retainers 408 and 416 may be elongated and/or compressed in order to exert force and/or release pressure. Via force exertion and release, the springs may affix the first and second windings 406, 412 to the rotor core 402 and stator core 404, respectively. The spring retainers may thus be the main coupling component of the rotating transformer, thereby eliminating the presence of adhesives. Spring retainers, unlike traditional adhesives used for coupling the windings to the core, may allow for full utilization of the temperature capabilities of the rotating transformer, and higher temperature operation may result in higher power density of the transformer. Avoiding use of adhesives may reduce overall manufacturing cost and cycle time as adhesives demand curing times and demand complex installations and installation equipment to handle the adhesive chemicals. Further, sustainability may be increased compared to using adhesives as recycling a spring retainer at end of life of the rotating transformer may be simpler and does not demand any burning process as is required with adhesives. Further still, the spring retainer may be a repairable part, whereas a rotating transformer as a whole may demand replacement if adhesives fail.

Turning now to FIGS. 5 and 6, methods of manufacture of a rotating transformer are shown. Specifically, FIG. 5 shows a flowchart illustrating a method 500 of manufacture of a static (e.g., stator) part of a rotating transformer and FIG. 6 shows a flowchart illustrating a method 600 of manufacture of a rotating (e.g., rotor) part of a rotating transformer. The methods 500 and 600 may be executed manually, via one or more mechanical strategies, (e.g., via mechanical equipment), and/or via coded instructions stored in memory of one or more machines. The methods herein are exemplary in nature and it should be understood that other methods of manufacture of a rotating transformer that includes a spring retainer for coupling of windings to a core are possible without departing from the scope of this disclosure.

Starting with FIG. 5, at 502, method 500 includes compressing a spring retainer of the rotating transformer. As described with respect to FIGS. 4A and 4B, in some examples, the rotating transformer may comprise a first spring retainer for the static part and a second spring retainer for the rotating part. The spring retainer of the static part may be compressed so as to store potential energy therein. Compression of the spring may increase the radius of the spring retainer.

At 504, method 500 includes shifting the spring retainer over the winding of the stator part. When the radius of the spring retainer is increased, the spring retainer may be shifted over (e.g., around) the winding. Thus, the spring retainer may be positioned around (e.g., circumferentially around) the static part of the rotating transformer. When compressed, the spring retainer may be loose enough around the static part to allow it to slide laterally into position.

At 506, method 500 includes releasing the compression pressure on the spring retainer. Releasing the pressure on the spring retainer may elongate the spring retainer back to its neutral position. Releasing the pressure may decrease the radius of the spring retainer, via conversion of the potential energy to kinetic energy. With the decreased radius, the spring retainer may exert a force, as a result of the release of pressure, on the winding. The force exerted on the winding may be exerted on the exterior of the winding, inward toward the stator core. Exertion of force on the winding may maintain the position of the winding with the stator core, in effect coupling the winding to the stator core.

Moving to FIG. 6, at 602, method 600 includes elongating the spring retainer. Again as noted, the rotating transformer may comprise a first spring retainer (e.g., first spring retainer 408) for the stator part and a second spring retainer (e.g., second spring retainer 416) for the rotor part. Elongating the spring retainer of the rotor part may decrease its radius.

At 604, method 600 includes wrapping the winding (e.g., the first winding 406) around the spring retainer. Wrapping the winding around the spring retainer may comprise inserting the spring retainer within an interior space of the winding, in some examples. In other examples, with the spring retainer in the decreased radius position, the winding may be wound about the spring retainer.

At 606, method 600 includes assembling the winding and spring retainer assembly within the rotor core. As described above, the winding of the rotor part may be positioned within an interior of the rotor core, when the rotating transformer is assembled. Once the winding is positioned about the elongated spring retainer, the rotor core may be positioned about the winding-spring assembly so that the winding and spring retainer are both positioned within the interior of the rotor core and the rotor core is circumferentially about the winding and spring retainer assembly.

At 608, method 600 includes releasing the elongation pressure of the spring retainer. Releasing the elongation pressure of the spring retainer may return the spring retainer to its neutral position, thereby increasing the radius of the spring retainer back to neutral. Releasing the elongation pressure, and consequently increasing the radius of the spring retainer may result in a force exerted outward on the winding, thereby pushing the winding against the rotor core, effectively coupling the winding to the rotor core. With the spring in its neutral position and radius, the position of the winding against the rotor core may be maintained by a force exerted on the winding. The force exerted on the winding may be exerted on an interior of the winding, outward toward the rotor core.

In this way, with the use of springs, coupling of the windings of a rotating transformer to the core may be produced without the need for adhesives. Without adhesives, full utilization of the temperature capabilities of the rotating transformer may be achieved, and higher temperature operation may result in higher power density of the transformer. Avoiding use of adhesives may reduce overall manufacturing cost and cycle time as adhesives demand curing times and demand complex installations and installation equipment to handle the adhesive chemicals. Further, sustainability may be increased compared to using adhesives as recycling a spring retainer at end of life of the rotating transformer may be simpler and does not demand any burning process as is required with adhesives. Further still, the spring retainer may be a repairable part, whereas a rotating transformer as a whole may demand replacement if adhesives fail.

The disclosure also provides support for an externally excited synchronous machine (EESM), comprising: a rotating transformer, comprising: a ferromagnetic core comprising a rotor core and a stator core, a first winding coupled to the rotor core via a first spring, and a second winding coupled to the stator core via a second spring. In a first example of the system, the first spring and the first winding are positioned within an interior of the rotor core. In a second example of the system, optionally including the first example, the second spring and the second winding are positioned about an exterior of the stator core. In a third example of the system, optionally including one or both of the first and second examples, the first and second windings are one of copper, aluminum, and any other conductive material coils. In a fourth example of the system, optionally including one or more or each of the first through third examples, the rotor core is a rotor ferromagnetic core and the stator core is a stator ferromagnetic core. In a fifth example of the system, optionally including one or more or each of the first through fourth examples, the first and second spring retainers are wire springs. In a sixth example of the system, optionally including one or more or each of the first through fifth examples, the first and second spring retainers are foil springs.

The disclosure also provides support for a method of manufacturing a rotating transformer, comprising: elongating a first spring retainer, wrapping a first winding around the first spring retainer, assembling the first winding and the first spring retainer within a rotor core, releasing elongation pressure on the first spring retainer, compressing a second spring retainer, shifting the second spring retainer over a second winding wrapped around a stator core, releasing compression pressure on the second spring retainer, and assembling the rotor core and stator core together. In a first example of the method, elongating the first spring retainer decreases a radius of the first spring retainer. In a second example of the method, optionally including the first example, compressing the second spring retainer increases a radius of the second spring retainer. In a third example of the method, optionally including one or both of the first and second examples, releasing elongation pressure on the first spring retainer results in a force exerted on the first winding by the first spring retainer. In a fourth example of the method, optionally including one or more or each of the first through third examples, the force exerted on the first winding by the first spring retainer maintains a position of the first winding, thereby coupling the first winding to the rotor core. In a fifth example of the method, optionally including one or more or each of the first through fourth examples, the force exerted on the first winding by the first spring retainer is exerted outward toward the rotor core. In a sixth example of the method, optionally including one or more or each of the first through fifth examples, releasing compression pressure on the second spring retainer results in a force exerted on the second winding by the second spring retainer. In a seventh example of the method, optionally including one or more or each of the first through sixth examples, the force exerted on the second winding by the second spring retainer maintains a position of the second winding, thereby coupling the second winding to the stator core. In a eighth example of the method, optionally including one or more or each of the first through seventh examples, the force exerted on the second winding is exerted inward toward the stator core.

The disclosure also provides support for a rotating transformer, comprising: a rotating part, wherein the rotating part comprises a rotor core coupled to a first winding via a first spring retainer, and a static part, wherein the static part comprises a stator core coupled to a second winding via a second spring retainer. In a first example of the system, the first winding is positioned within an interior of the rotor core and the first spring retainer is positioned within an interior of the first winding. In a second example of the system, optionally including the first example, the second winding is positioned around an exterior of the stator core and the second spring retainer is positioned around an exterior of the second winding. In a third example of the system, optionally including one or both of the first and second examples, the first spring retainer is configured to exert force on the first winding to couple the first winding to the rotor core and the second spring retainer is configured to exert force on the second winding to couple the second winding to the stator core.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An externally excited synchronous machine (EESM), comprising:
a rotating transformer, comprising:
a ferromagnetic core comprising a rotor core and a stator core;
a first winding coupled to the rotor core via a first spring; and
a second winding coupled to the stator core via a second spring.

2. The EESM of claim 1, wherein the first spring and the first winding are positioned within an interior of the rotor core.

3. The EESM of claim 1, wherein the second spring and the second winding are positioned about an exterior of the stator core.

4. The EESM of claim 1, wherein the first and second windings are one of copper, aluminum, and any other conductive material coils.

5. The EESM of claim 1, wherein the rotor core is a rotor ferromagnetic core and the stator core is a stator ferromagnetic core.

6. The EESM of claim 1, wherein the first and second spring retainers are wire springs.

7. The EESM of claim 1, wherein the first and second spring retainers are foil springs.

8. A method of manufacturing a rotating transformer, comprising:
elongating a first spring retainer;
wrapping a first winding around the first spring retainer;
assembling the first winding and the first spring retainer within a rotor core;
releasing elongation pressure on the first spring retainer;
compressing a second spring retainer;
shifting the second spring retainer over a second winding wrapped around a stator core;
releasing compression pressure on the second spring retainer; and
assembling the rotor core and stator core together.

9. The method of claim 8, wherein elongating the first spring retainer decreases a radius of the first spring retainer.

10. The method of claim 8, wherein compressing the second spring retainer increases a radius of the second spring retainer.

11. The method of claim 8, wherein releasing elongation pressure on the first spring retainer results in a force exerted on the first winding by the first spring retainer.

12. The method of claim 11, wherein the force exerted on the first winding by the first spring retainer maintains a position of the first winding, thereby coupling the first winding to the rotor core.

13. The method of claim 11, wherein the force exerted on the first winding by the first spring retainer is exerted outward toward the rotor core.

14. The method of claim 8, wherein releasing compression pressure on the second spring retainer results in a force exerted on the second winding by the second spring retainer.

15. The method of claim 14, wherein the force exerted on the second winding by the second spring retainer maintains a position of the second winding, thereby coupling the second winding to the stator core.

16. The method of claim 14, wherein the force exerted on the second winding is exerted inward toward the stator core.

17. A rotating transformer, comprising:
a rotating part, wherein the rotating part comprises a rotor core coupled to a first winding via a first spring retainer; and
a static part, wherein the static part comprises a stator core coupled to a second winding via a second spring retainer.

18. The rotating transformer of claim 17, wherein the first winding is positioned within an interior of the rotor core and the first spring retainer is positioned within an interior of the first winding.

19. The rotating transformer of claim 17, wherein the second winding is positioned around an exterior of the stator core and the second spring retainer is positioned around an exterior of the second winding.

20. The rotating transformer of claim 17, wherein the first spring retainer is configured to exert force on the first winding to couple the first winding to the rotor core and the second spring retainer is configured to exert force on the second winding to couple the second winding to the stator core.
